(19) United States
(12) Patent Application Publication
(10) Pub. No.: US 2019/0207554 A1
(43) Pub. Date: Jul. 4, 2019

(54) A DUAL AXIS SOLAR TRACKER ASSEMBLY

(71) Applicant: C I CORPORATION PTY LTD, Southport, Queensland (AU)

(72) Inventor: Ahmed El Sarty, Queensland (AU)

(21) Appl. No.: 16/331,105

(22) PCT Filed: Sep. 7, 2017
(86) PCT No.: PCT/AU2017/050971

§ 371 Date: Mar. 6, 2019

(30) Foreign Application Priority Data
Sep. 7, 2016 (AU) 2016903582

(51) Int. Cl. H02S 20/32; F24S 30/455; F24S 25/12; F24S 50/20

(52) U.S. Cl. CPC H02S 20/32; F24S 50/20; F24S 25/12; F24S 30/455

(57) ABSTRACT

A dual axis solar tracker assembly including a mount to mount the tracker assembly relative to a surface, a mounting assembly to mount at least one photovoltaic panel or solar thermal concentrator relative thereto, a junction mount to mount the mounting assembly relative to the mount, the junction mount including a first rotatable joint assembly to allow pivoting of the mounting assembly in a first plane and a second rotatable joint assembly to allow pivoting of the mounting assembly in a second plane substantially perpendicular to the first plane.

### TECHNICAL FIELD

The present invention relates to solar tracking assemblies and particularly to a dual axis solar tracker assembly.

### BACKGROUND ART

U.S. Pat. No. 7,252,084 discloses a solar tracker and also provides a useful discussion of prior art as follows:

A solar collector collects solar radiation to produce solar cell output voltage. One type of solar collector moves with the sun, to face toward the sun as the sun changes its position during a daylight period. The elevation angle of the sun changes as the sun ascends and descends, and the horizontal angle of the sun changes with the movement of the sun from horizon to horizon. A solar tracking system adjusts an elevation angle of the solar collector and adjusts a horizontal angle of the solar collector to correspond with changes in the sun's position throughout a daylight period.

Prior to the invention, solar tracking for a solar collector was mathematically calculated. A computer program was devised to produce solar tracking for different days of the year, and for different latitude and longitude positions. The computer program controlled drive motors that moved the solar collector in a manner to track the sun.

U.S. Pat. No. 4,628,142 discloses a solar tracking system that foregoes a computer program. The system includes a cable that lengthens and shortens to move a solar collector about a horizontal axis. The cable is attached to coils of shape memory alloys that absorb solar energy. When illuminated by the sun, the coils of shape memory alloys uncoil, which lengthen the cable. When shaded from the sun, the shape memory alloys form tighter coils, which shorten the cable.

U.S. Pat. No. 4,832,001 discloses a solar collector having two solar heated canisters containing Freon. The canisters are interconnected to exchange Freon from one canister to another. When both canisters are illuminated by the sun, they absorb solar energy to evaporate the Freon to a gaseous state. When one of the canisters is shaded from the sun, the Freon in the shaded canister condenses to a liquid state, making the shaded canister containing liquid Freon heavier than the illuminated canister containing gaseous Freon. The heavier weight moves the solar collector until both canisters become illuminated by the sun, which evaporates the Freon and equalizes the canister weights.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a dual axis solar tracker assembly, which may at least partially overcome at least one of the abovementioned disadvantages or provide the consumer with a useful or commercial choice.

With the foregoing in view, the present invention in one form, resides broadly in a dual axis solar tracker assembly including

a mount to mount the tracker assembly relative to a surface;
a mounting assembly to mount at least one photovoltaic panel or solar thermal concentrator relative thereto;
a junction mount to mount the mounting assembly relative to the mount, the junction mount including

a first rotatable joint assembly to allow pivoting of the mounting assembly in a first plane and

a second rotatable joint assembly to allow pivoting of the mounting assembly in a second plane substantially perpendicular to the first plane.

Each of the first rotatable joint assembly and the second rotatable joint assembly is preferably associated with a respective at least one link member to attach a first dual axis solar tracker assembly to an adjacent second dual axis solar tracker assembly of the same configuration to allow the mounting assembly of multiple dual axis and solar tracker assemblies to be oriented simultaneously.

The dual axis solar tracker of the present invention is preferably used to mount one or more photovoltaic panels or solar thermal concentrators relative thereto and to allow movement of the photovoltaic panels or solar thermal concentrators as required to track the movement of the sun and maximise electrical or solar thermal output. In particular, the dual axis solar tracker of the invention is adapted to be used together with other solar trackers of the same configuration and to connect the multiple solar trackers to or relative to one another in order to allow the plurality of solar trackers to be aligned or oriented all at once.

The particular configuration of the dual axis solar tracker of the present invention allows dual axis movement, even when the solar tracker is linked to adjacent, similar solar tracker assemblies.

The dual axis solar tracker of the present invention includes a mount to mount the tracker assembly relative to a surface. The function of the mount is not only to mount the tracker assembly relative to a surface but preferably also to maintain the solar tracker at a height sufficient relative to the surface to allow movement of the solar tracker in both axes as required.

Any type of mount may be used. Preferably, the mount will be elongate and will normally be configured as an elongate member for simplicity but a multi part assembly could be used. Preferably, the junction mount of the solar tracker of the present invention will be provided immediately above the preferred elongate member.

The mount may have any shape. In particular, the preferred elongate member is typically circular in cross sectional shape to form an elongate cylindrical member. This may also be rectangular for roof mounted units.

A mounting flange is normally provided at each of the lower end of the upper end of the preferred elongate mount. Preferably, at least one, and normally a number of openings is provided through each of the mounting flange in order to attach the mount to or relative to the surface in relation to the lower mounting flange and to attach the junction mount to or relative to the mounting flange provided at an upper end of the preferred elongate mount.

The mount is preferably mounted to or relative to a surface in order to extend substantially perpendicularly to the surface. However, the mount is intended to mount the dual axis solar tracker in an upright position, with sufficient clearance relative to the surface to allow the solar tracker to move through a range of movement, in both of the dual axes.

The dual axis solar tracker of the present invention includes a mounting assembly to mount at least one photovoltaic panel or solar thermal concentrator relative thereto. The mounting assembly will typically hold generally at least one planar photovoltaic panel or solar thermal concentrator and could be used to hold more than one photovoltaic panel or solar thermal concentrator. Clearly it is important that the mounting assembly hold the at least one photovoltaic panel or solar thermal concentrator securely through movement of the solar tracker. It is also important to recognise that the solar tracker may function in harsh conditions and therefore, the photovoltaic panel(s) or solar thermal concentrator(s) will be securely mounted to the mounting assembly.

The preferred mounting assembly includes a pair of elongate support rails in order to support at least one photovoltaic panel or solar thermal concentrator relative thereto. The support rails are preferably spaced from one another and extend substantially parallel to one another. The support rails will normally support the panel by extending at or closely to side edge of at least one of the photovoltaic panels or solar thermal concentrators and therefore, each of the support rails is typically dimensioned substantially similarly to a dimension of the at least one photovoltaic panel or solar thermal concentrator to be supported relative thereto.

The support rails will preferably be rectangular in cross-sectional shape and a support surface of each of the support rails will preferably be substantially coplanar in order to abut a rear surface of the at least one photovoltaic panel or solar thermal concentrator.

Any material of construction can be used but it is preferred that the support rails be hollow in order to reduce the weight of the support rails but to provide the requisite strength.

The support rails may be provided as a part of a support frame but the support rails are preferably mounted relative to a support frame. The support frame is normally formed from a number of members attached to or relative to each other with members preferably extending in at least two directions which are substantially perpendicular to one another in order to form a regular array. The mounting of the support rails relative to the support frame will typically space the support rails from one another.

It is preferred that at least some of the frame members of the support frame are hollow, preferably box members. In particular, there are preferably at least three spaced apart substantially parallel box members in the support frame which extend substantially parallel to the support rails. There are preferably at least three spaced apart, substantially parallel members in the support frame which extend substantially perpendicularly to the support rails and are attached to the box members of the support frame. Preferably, the members of the support frame extend substantially perpendicularly to the support rails are preferably planar.

The support frame is preferably associated with one or more link members in order to provide one or more attachment points to attach the support frame relative to the junction mount. Typically, planar members of the support frame are preferably associated with one or more link members. In particular, it is preferred that a pair of link members be attached, one shorter length link member and one longer link member.

According to a most preferred embodiment, an elongate rod forming a part of the first rotatable joint assembly will extend between the shorter length link member and the longer length link member. In addition, the longer link member will typically be provided with an attachment point to attach a transverse link in order to attach multiple solar trackers of the same configuration together.

Preferably, each of the link members is formed in a unitary configuration with a transverse portion to attach the support rails and extend substantially downwardly therefrom. An attachment structure or formation will typically be provided on both link members in order to attach the elongate rod or shaft to both of the link members. In attachment structure or formation will also normally be provided at a lower end in order to attach the transverse link.

The dual axis solar tracker of the present invention includes a junction mount to mount the mounting assembly relative to the mount, the junction mount including a first rotatable joint assembly to allow pivoting of the mounting assembly in a first plane and a second rotatable joint assembly to allow pivoting of the mounting assembly in a second plane substantially perpendicular to the first plane.

As mentioned above, the junction mount is typically mounted directly above the elongate mount of the solar tracker assembly. Preferably, the junction mount is mounted directly to the upper flange of the mount.

The junction mount will preferably include a dual axis housing relative to which the first rotatable joint assembly and second rotatable joint assembly are formed. In particular, the dual axis housing will preferably be substantially rectangular in cross-sectional shape and hollow. The housing will normally be formed from four walls, each of which is planar, two walls being substantially perpendicular to the other two walls in order to define the preferred substantially rectangular housing.

It is further preferred that two of the walls of the housing have arcuate lower portions or wings. An opening is preferably formed through each of the arcuate lower wings. An elongate shaft preferably extends through each of the openings in order to form the second rotatable joint assembly. In a particularly preferred form, the second rotatable joint assembly will be referred to as the azimuth joint assembly used to move the solar tracker and particularly, the mounting assembly to track the sun's azimuth.

The dual axis housing is typically mounted above the mounting flange at an upper end of the elongate mount. The dual axis housing is preferably mounted, spaced from the mounting flange via the mounting to the elongate shaft of the second joint assembly. In particular, the elongate shaft of the second joint assembly is preferably mounted relative to the mounting flange an upper end of the mount using a pair of bearing mounts allowing rotation of the housing which is preferably fixed relative to the elongate shaft of the second joint assembly according to rotation of the elongate shaft of the second joint assembly.

The elongate shaft of the second joint assembly may be any shape, but is preferably elongate and cylindrical. It is further preferred that the elongate shaft of the second joint assembly is attached to a pair of laterally extending arms which, in use, are normally attached to the laterally extending arms of other, adjacent solar tracking assemblies. The elongate shaft of the second joint assembly is typically straight extending through and mounting the dual axis housing relative thereto. It is preferred that the elongate shaft of the second joint assembly is solid.

The elongate shaft of the second joint assembly may be provided with a flattened, land portion in order to engage with a flattened, land portion provided on the openings through the arcuate wings of the dual axis housing in order to drive movement of the dual axis housing.

The laterally extending arms will typically extend on either side of the dual axis housing and in a particularly preferred form, each of the laterally extending aims extends briefly coaxially with the elongate shaft of the second joint assembly and then has a depending length followed by a further laterally extending length which extends further away from the mount of the solar tracker. Each of the laterally extending arms is preferably hollow. Each of the laterally extending arms is normally attached to an end of the elongate shaft of the second joint assembly via an attachment flange or similar.

This configuration preferably forms an upside down, substantially U-shaped arm assembly with a pair of laterally extending portions, one on either side of the solar tracker assembly in order to connect to other solar tracker assemblies in series. As mentioned above, the elongate shaft of the second joint assembly is typically mounted to the dual axis housing or attached to the dual axis housing in order to cause rotation of the housing about the elongate shaft of the second joint assembly.

The first elongate shaft or rod of the first rotatable joint assembly is also mounted to the dual axis housing. Preferably, the first elongate shaft or rod is mounted through the two walls of the dual axis housing which are substantially perpendicular to the walls relative to which the second elongate shaft is mounted. The result of this mounting is that the first elongate shaft or rod will preferably be substantially perpendicular to the second elongate shaft.

According to a preferred embodiment, the first elongate shaft or rod can rotate relative to the dual axis housing. As mentioned above, the first elongate shaft or rod typically mounts the mounting assembly relative thereto and therefore, rotation of the first elongate shaft or rod will also rotate the mounting assembly. In a preferred embodiment, the first elongate shaft or rod is mounted at its ends to the respective short link and long link provided on the photovoltaic panel mounting assembly and particularly the support frame.

Preferably, the first elongate shaft or rod is mounted relative to the dual axis housing through bearing is attached to the housing and through which the first elongate shaft or rod is mounted for rotation. The first elongate shaft or rod can be any shape but a circular cross-section is preferred. The first elongate shaft or rod may be hollow or solid.

The rotation of the first elongate shaft or rod will typically rotate the photovoltaic panel or solar thermal concentrator mount through the connection to the preferred link members and as mentioned above, the longer length link will typically be used to attach the solar tracker to adjacent assemblies in series through the provision of an elongate transverse link.

The elongate transverse link is preferably planar and will normally attach to respective long links of adjacent solar tracker assemblies. The attachment is normally pivotable about a pivot pin but force can be transmitted to the long link through the pivot pin which causes changes in angle of the mounting assembly.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an isometric view of a dual axis solar tracker assembly of a preferred embodiment of the present invention.

FIG. 2 is an isometric view of a mounting assembly according to a preferred embodiment of the present invention.

FIG. 3 is an isometric view of the mount from the assembly illustrated in FIG. 1.

FIG. 4 is a plan view of the solar tracker assembly illustrated in FIG. 1.

FIG. 5 is a sectional front elevation view of the solar tracker assembly illustrated in FIG. 4 along line B-B.

FIG. 6 is a detailed sectional of the portion identified on FIG. 5 using reference “CC”.

FIG. 7 is a plan view of the solar tracker assembly illustrated in FIG. 1.

FIG. 8 is a sectional front elevation view of the solar tracker assembly illustrated in FIG. 7 along line D-D.

FIG. 9 is a detailed sectional of the portion identified on FIG. 8 using reference

FIG. 10 is a detailed isometric view of the junction mount of the assembly illustrated in FIG. 1.

FIG. 11 is an isometric detailed view of a portion of the junction mount illustrated in FIG. 10.

### DESCRIPTION OF EMBODIMENTS

According to a particularly preferred embodiment of the present invention, a dual axis solar tracker assembly 10 is provided.

The dual axis solar tracker assembly 10 illustrated in the accompanying Figures includes a mount 11 to mount the tracker assembly 10 relative to a surface (not shown), a mounting assembly 12 to mount at least one photovoltaic panel or solar thermal concentrator (not shown) relative thereto, and a junction mount 13 to mount the mounting assembly 12 relative to the mount 11. The junction mount 13 includes a first rotatable joint assembly to allow pivoting of the mounting assembly 12 in a first plane and a second rotatable joint assembly to allow pivoting of the mounting assembly 12 in a second plane substantially perpendicular to the first plane.

Each of the first rotatable joint assembly and the second rotatable joint assembly is associated with a respective at least one link member to attach a first dual axis solar tracker assembly 10 to an adjacent second dual axis solar tracker assembly 10 of the same configuration to allow the mounting assemblies 12 of multiple dual axis and solar tracker assemblies 10 to be oriented simultaneously.

The dual axis solar tracker of the present invention is preferably used to mount one or more photovoltaic panels or solar thermal concentrators relative thereto and to allow movement of the photovoltaic panels as required to track the movement of the sun and maximise electrical output. In particular, the dual axis solar tracker of the invention is adapted to be used together with other solar trackers of the same configuration and to connect the multiple solar trackers to or relative to one another in order to allow the plurality of solar trackers to be aligned or oriented all at once.

The particular configuration of the dual axis solar tracker of the present invention allows dual axis movement, even when the solar tracker is linked to adjacent, similar solar tracker assemblies.

The function of the mount 11 is not only to mount the tracker assembly 10 relative to a surface but also to maintain the mounting assembly 12 at a height above the surface to allow movement of the mounting assembly 12 in both axes as required.

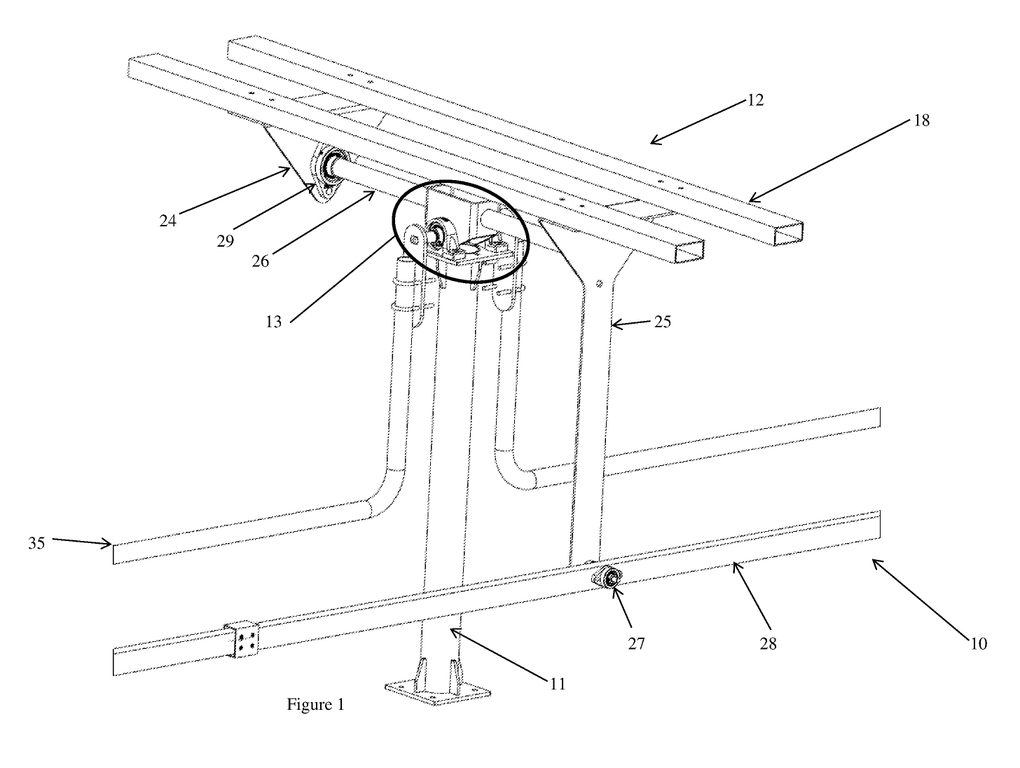

In the embodiment illustrated in FIG. 3 in particular, the mount 11 is an elongate member for simplicity but a multi part assembly could be used. As illustrated in FIG. 1, the junction mount 13 of the preferred embodiment of solar tracker is provided immediately above the elongate mount 11.

The elongate mount 11 illustrated is circular in cross sectional shape to form an elongate cylindrical member. An upper mounting flange 14 is provided at the upper end of the elongate mount 11 and a lower mounting flange 15 is provided at the lower end of the elongate mount 11. A number of openings 16 are provided through each of the upper mounting flange 14 to attach the junction mount and the lower mounting flange 15 in order to attach the mount 11 to or relative to the surface.

The mount is preferably mounted to or relative to a surface in order to extend substantially perpendicularly to the surface. Bracing members 17 are also provided to strengthen the elongate mount 11.

The mounting assembly 12 typically holds at least one planar photovoltaic panel or solar thermal concentrator (not shown). Clearly it is important that the mounting assembly 12 hold the at least one photovoltaic panel securely through movement of the solar tracker 10. It is also important to recognise that the solar tracker 10 may function in harsh conditions and therefore, the photovoltaic panel(s) or solar thermal concentrator(s) will be securely mounted to the panel mounting assembly 12.

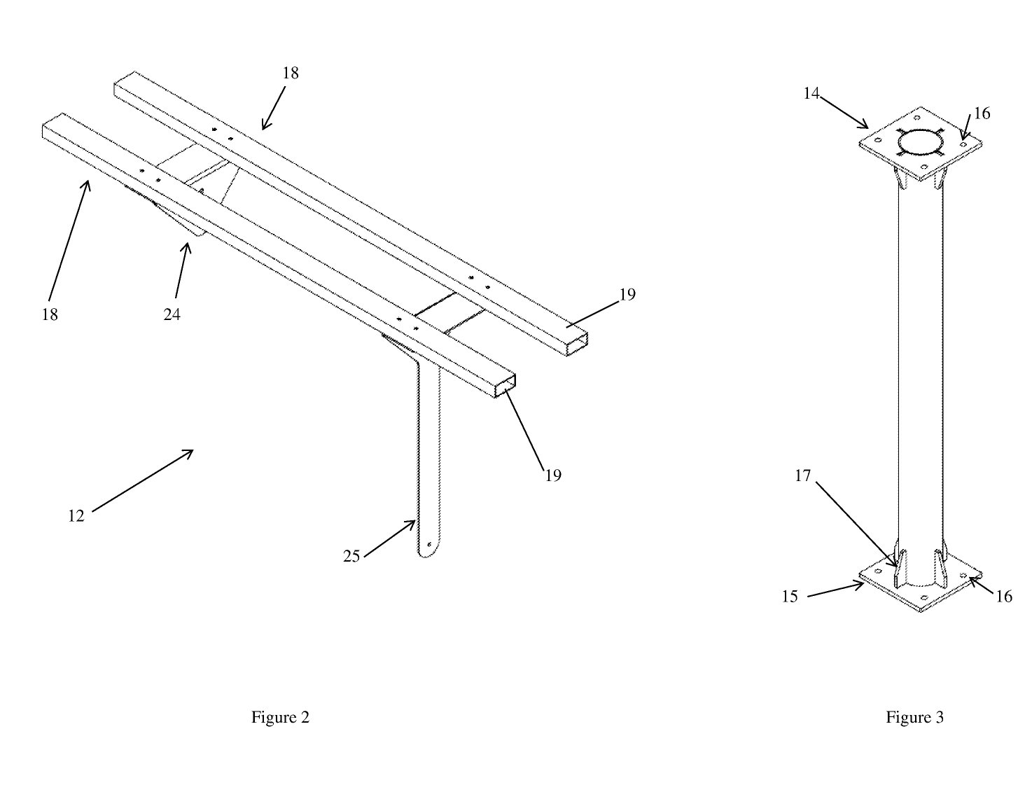

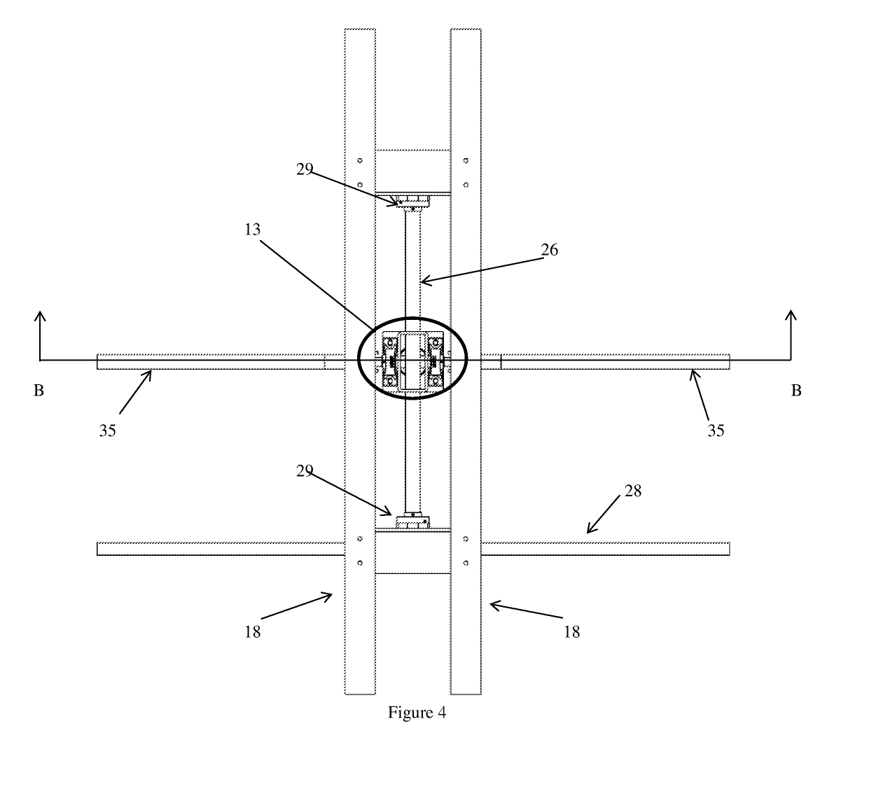

The preferred mounting assembly 12 illustrated best in FIG. 2 includes a pair of elongate support rails 18 in order to support at least one photovoltaic panel or solar thermal concentrator relative thereto. The support rails 18 are spaced from one another and extend substantially parallel to one another. The support rails 18 will normally support the photovoltaic panel or solar thermal concentrator by extending at or closely to a end edge of at least one of the photovoltaic panels or solar thermal concentrators and therefore, each of the support rails 18 is typically dimensioned substantially similarly to a dimension of the at least one photovoltaic panel to be supported relative thereto.

The support rails 18 illustrated are rectangular in cross-sectional shape and an upper support surface 19 of each of the support rails 18 is substantially coplanar in order to abut a rear surface of the at least one photovoltaic panel.

Any material of construction can be used but it is preferred that the support rails 18 are hollow in order to reduce the weight of the support rails 18 but to provide the requisite strength.

As illustrated, the support rails 18 are mounted relative to one or more link members in order to provide one or more attachment points to attach the support rails 18 relative to the junction mount 13. Typically, the support rails 18 are each associated a pair of link members, one shorter length link member 24 and one longer link member 25. Each of the link members preferably have a transversely extending portion relative to which the support rails 18 are attached as illustrated in FIG. 2.

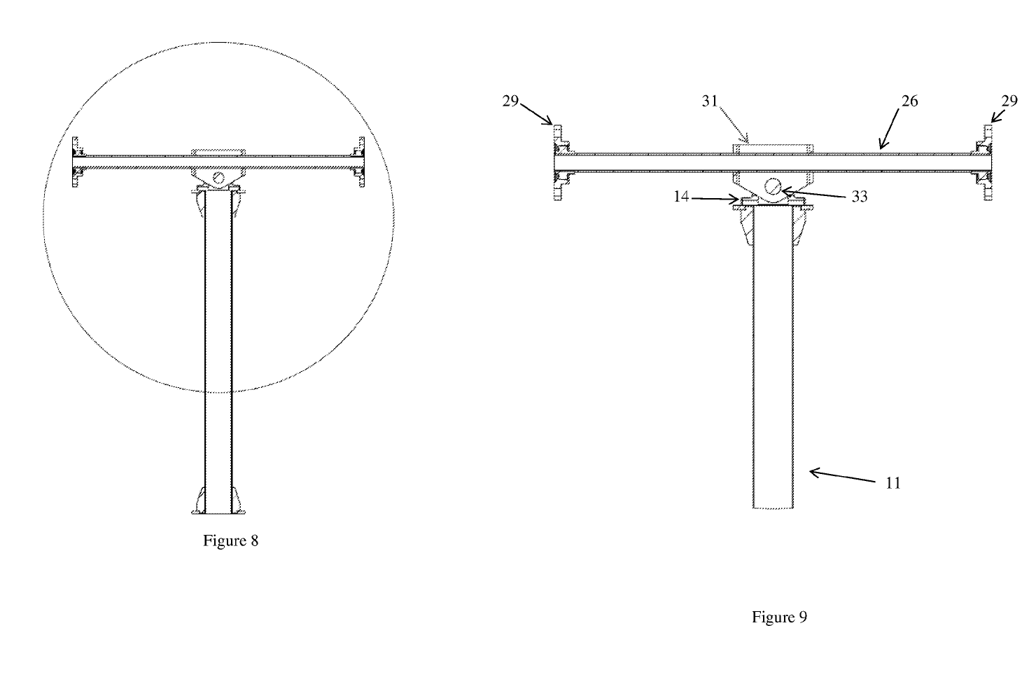

According to the illustrated embodiment, a first elongate rod 26 which is a part of the first rotatable joint assembly (illustrated best in FIG. 9) extends between the shorter length link member 24 and the longer length link member 25. As illustrated in FIGS. 1, 2 and 8, the longer link member 25 is provided with an attachment point 27 to attach a transverse link 28 in order to attach multiple solar trackers of the same configuration together.

Each of the link members 24, 25 is formed in a unitary configuration with extends substantially downwardly from the support rails 18. An attachment bearing 29 is provided on both link members 24, 25 in order to attach the first elongate rod 26 to both of the link members 24, 25.

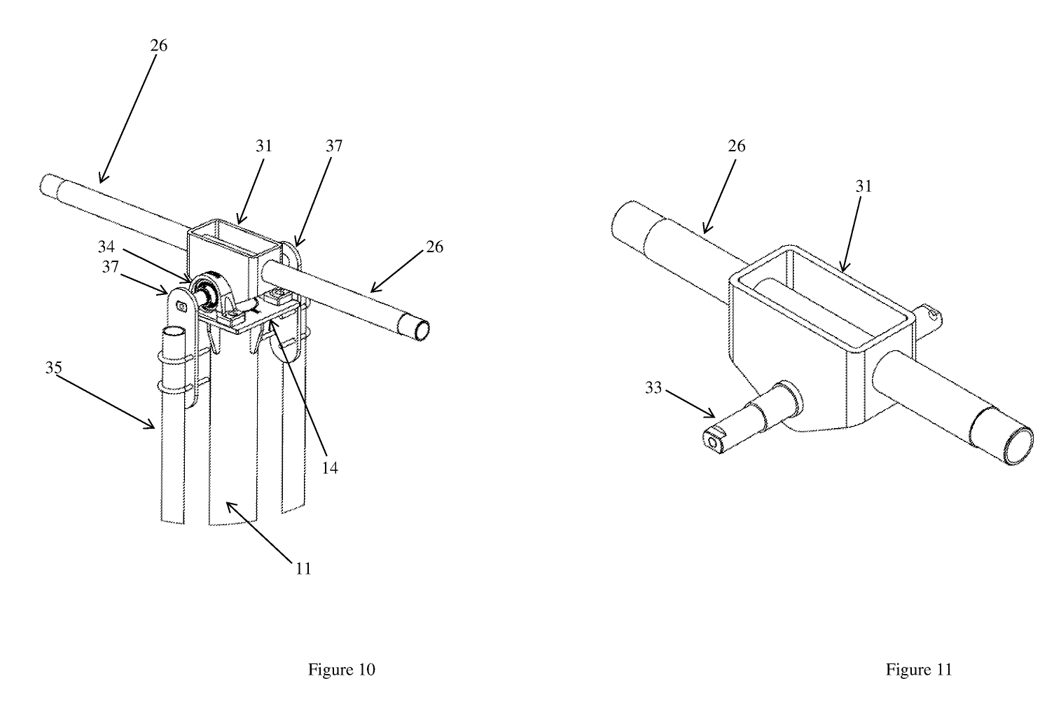

As mentioned above, the junction mount 13 is typically mounted directly above the elongate mount 11 of the solar tracker assembly 10, preferably directly to the upper flange 14 of the mount 11. The junction mount 13 is best illustrated in FIG. 10.

The junction mount 13 includes a dual axis housing 31 (best seen in FIG. 11) relative to which the first rotatable joint assembly and second rotatable joint assembly are formed. In the form illustrated in FIG. 11, the dual axis housing 31 is substantially rectangular in cross-sectional shape and hollow. The housing 31 is formed from four walls, each of which is planar, two walls being substantially perpendicular to the other two walls in order to define the preferred substantially rectangular housing.

Two of the walls of the housing have arcuate lower portions or wings with an opening formed through each of the arcuate lower wings. A second elongate shaft 33 extends through each of the openings in order to form the second rotatable joint assembly. The second rotatable joint assembly is referred to as the azimuth joint assembly and is used to move the solar tracker and particularly, the mounting assembly 12 to track the sun's azimuth.

The dual axis housing 31 is mounted above the upper mounting flange 14 at an upper end of the elongate mount 11. The dual axis housing 31 is mounted spaced from the upper mounting flange 14 via the mounting to the second elongate shaft 33. In particular, the second elongate shaft 33 is mounted relative to the upper mounting flange 14 using a pair of bearing mounts 34 allowing rotation of the housing 31, which is fixed relative to the second elongate shaft 33, according to rotation of the second elongate shaft 33.

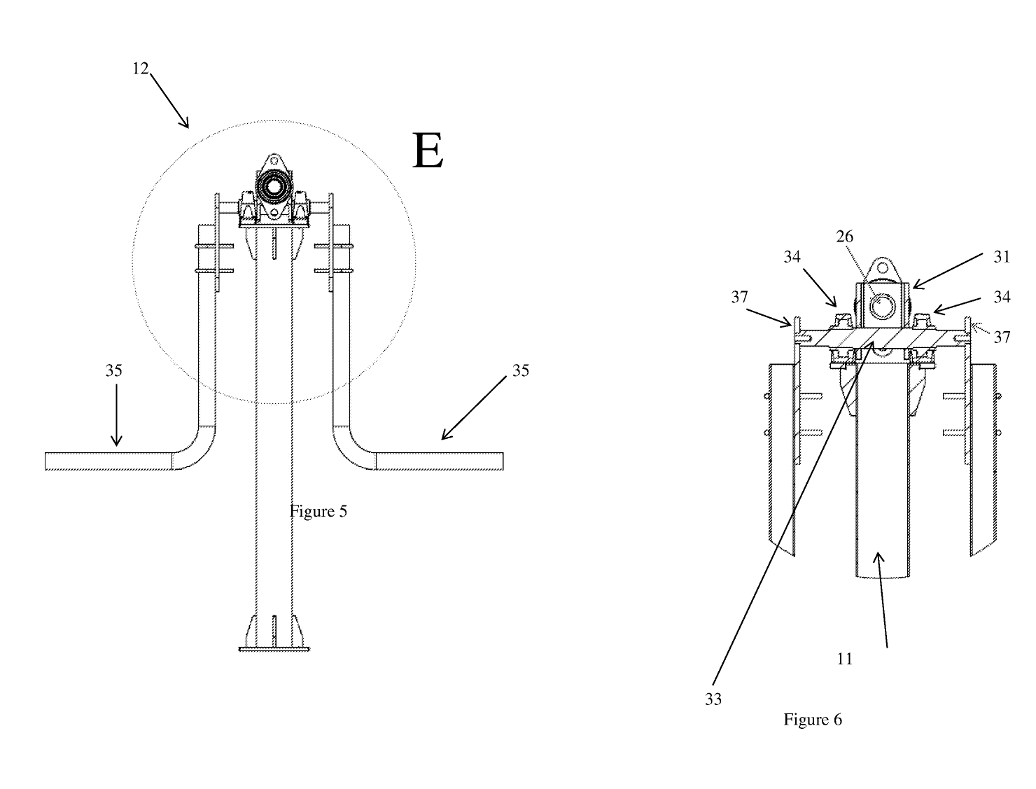

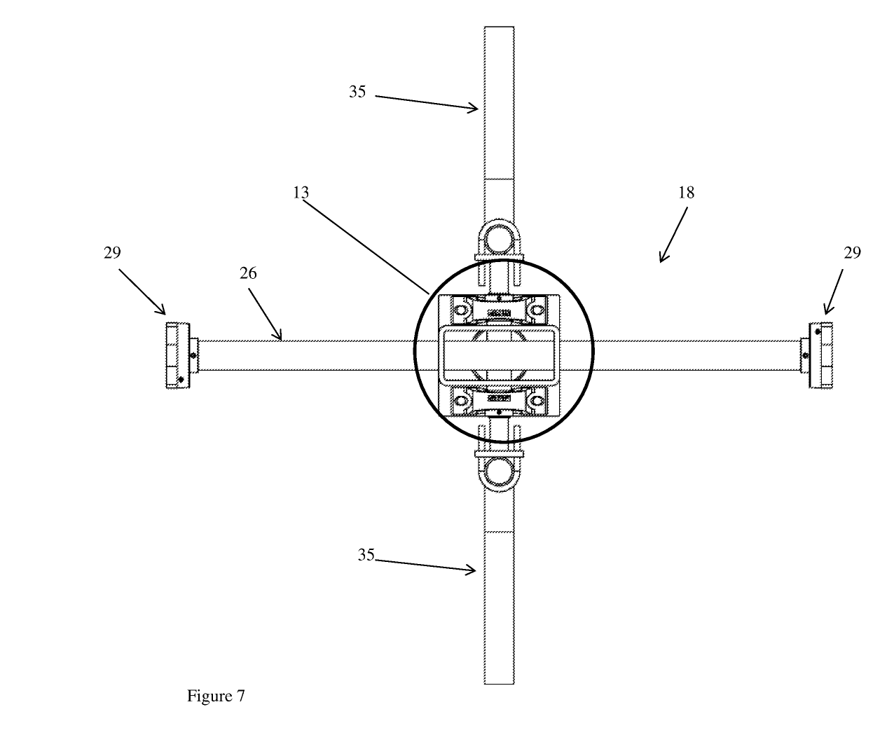

The second elongate shaft 33 may be any shape, but is preferably elongate and cylindrical as seen best in FIG. 6. The second elongate shaft is attached to a pair of laterally extending arms 35 which, in use, are normally attached to the laterally extending arms of other, adjacent solar tracking assemblies 10. The second elongate shaft 33 is typically straight extending through and mounting the dual axis housing 31 relative thereto. It is preferred that the second elongate shaft 33 is solid.

The second elongate shaft 33 may be provided with a flattened, land portion in order to engage with a flattened, land portion provided on the openings through the arcuate wings of the dual axis housing 31 in order to drive movement of the dual axis housing 31.

The laterally extending arms 35 extend on either side of the dual axis housing 31 and in a particularly preferred form, each of the laterally extending arms is attached to the second elongate shaft 33 via a mounting plate, the laterally extending arms having a depending length followed by a laterally extending length which extends further away from the mount 11 of the solar tracker. Each of the laterally extending arms 35 is preferably hollow. Each of the laterally extending arms 35 is normally attached to an end of the elongate shaft of the second joint assembly via an attachment flange 37 attached to the laterally extending arm 35 as illustrated in FIG. 6.

This configuration preferably forms an upside down, substantially U-shaped arm assembly with a pair of laterally extending portions 35, one on either side of the solar tracker assembly 10 in order to connect to other solar tracker assemblies in series. As mentioned above, the second elongate shaft 33 is typically mounted to the dual axis housing 31 or attached to the dual axis housing 31 in order to cause rotation of the housing 31 about axis of the second elongate shaft 33.

The first elongate rod 26 is also mounted to the dual axis housing 31 as seen in FIG. 9. The first elongate rod 26 is mounted through the two walls of the dual axis housing 31 which are substantially perpendicular to the walls relative to which the second elongate shaft 33 is mounted. The result of this mounting is that the first elongate rod 26 is substantially perpendicular to the second elongate shaft 33 as shown in FIG. 10.

According to a preferred embodiment, the first elongate rod 26 can rotate relative to the dual axis housing 31 due to the preferred circular openings receiving a preferably circular cross-section first elongate rod 26. As mentioned above, the first elongate rod 26 typically mounts the mounting assembly 12 relative thereto and therefore, rotation of the first elongate rod 26 will also rotate the mounting assembly 12. In a preferred embodiment, the first elongate rod 26 is mounted at its ends to the respective short link 24 and long link 25 provided on the mounting assembly 12.

The first elongate rod 26 can be any shape but a circular cross-section is preferred. The first elongate rod 26 is also preferably solid.

The rotation of the first elongate rod 26 will typically rotate the mounting assembly 12 through the connection to the link members 24, 25 and as mentioned above, the longer length link 25 will typically be used to attach the solar tracker to adjacent assemblies in series through the provision of an elongate transverse link 28.

The elongate transverse link 28 is preferably planar and will normally attach to respective long links 25 of adjacent solar tracker assemblies 10. The attachment is normally pivotable about a pivot pin but force can be transmitted to the long link 25 through the pivot pin which causes changes in angle of the mounting assembly 12.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A dual axis solar tracker assembly including a mount to mount the tracker assembly relative to a surface, a mounting assembly to mount at least one photovoltaic panel or solar thermal concentrator relative thereto, a junction mount to mount the mounting assembly relative to the mount, the junction mount including a first rotatable joint assembly to allow pivoting of the mounting assembly in a first plane and a second rotatable joint assembly to allow pivoting of the mounting assembly in a second plane substantially perpendicular to the first plane.

2. A dual axis solar tracker assembly as claimed in claim 1 wherein each of the first rotatable joint assembly and the second rotatable joint assembly is associated with a respective at least one link member to attach a first dual axis solar tracker assembly to an adjacent second dual axis solar tracker assembly of the same configuration to allow the mounting assembly of a first dual axis solar tracker assembly to an adjacent second dual axis solar tracker assembly of the same configuration to be oriented simultaneously.

3.-4. (canceled)

5. A dual axis solar tracker assembly as claimed in claim 1 wherein the mount includes at least one elongate member with the junction mount of the solar tracker provided uppermost.

6. A dual axis solar tracker assembly as claimed in claim 1 wherein a mounting flange is provided at each of a lower end and an upper end of the mount with at least one opening provided through each of the mounting flanges in order to attach the mount to or relative to a surface in relation to the mounting flange at the lower end and to attach the junction mount to or relative to the mounting flange provided at the upper end.

7. A dual axis solar tracker assembly as claimed in claim 1 wherein the mounting assembly includes a pair of spaced apart, elongate support rails in order to support at least one photovoltaic panel or solar thermal concentrator relative thereto

8. A dual axis solar tracker assembly as claimed in claim 7 wherein the support rails support the panel by extending at or closely to a respective side edge of at least one of the photovoltaic panels or solar thermal concentrators.

9. A dual axis solar tracker assembly as claimed in claim 7 wherein the support rails are mounted relative to a support frame formed from a number of members attached to or relative to each other, with members extending in at least two directions which are substantially perpendicular to one another in order to form a regular array.

10. A dual axis solar tracker assembly as claimed in claim 9 wherein the support frame is associated with one or more link members in order to provide one or more attachment points to attach the support frame relative to the junction mount.

11. A dual axis solar tracker assembly as claimed in claim 10 wherein a pair of link members is provided, one shorter length link member and one longer link member.

12. A dual axis solar tracker assembly as claimed in claim 11 wherein an elongate rod forming a part of the first rotatable joint assembly extends between the shorter length link member and the longer length link member.

13. A dual axis solar tracker assembly as claimed in claim 11 wherein the longer link member is provided with an attachment point to attach a transverse link in order to attach multiple solar trackers of the same configuration together.

14. A dual axis solar tracker assembly as claimed in claim 11 wherein each of the link members is formed in a unitary configuration with a transverse portion to attach the support rails and extend substantially downwardly therefrom and further include at least one attachment structure or formation.

15. A dual axis solar tracker assembly as claimed in claim 11 wherein the junction mount includes a dual axis housing relative to which the first rotatable joint assembly and second rotatable joint assembly are formed.

16. A dual axis solar tracker assembly as claimed in claim 15 wherein the dual axis housing has a number of walls, at least two of the walls of the housing having arcuate lower portions or wings with at least one opening formed through each of the arcuate lower wings and an elongate shaft extends through each of the openings in order to form the second rotatable joint assembly.

17. A dual axis solar tracker assembly as claimed in claim 16 wherein the dual axis housing is mounted relative to the mount via the elongate shaft of the second joint assembly being mounted relative to the mount using a pair of bearing mounts allowing rotation of the dual axis housing which is fixed relative to the elongate shaft of the second joint assembly according to rotation of the elongate shaft of the second joint assembly.

18. A dual axis solar tracker assembly as claimed in claim 16 wherein a pair of laterally extending arms extend on either side of the dual axis housing attached to an end of the elongate shaft of the second joint assembly via an attachment flange or similar.

19. A dual axis solar tracker assembly as claimed in claim 16 wherein a first elongate shaft or rod of the first rotatable joint assembly is also mounted to the dual axis housing through two walls of the dual axis housing which are substantially perpendicular to the two walls relative to which the second elongate shaft is mounted.

20. A dual axis solar tracker assembly as claimed in claim 19 wherein the first elongate shaft or rod can rotate relative to the dual axis housing.

21. A dual axis solar tracker assembly as claimed in claim 20 wherein the first elongate shaft or rod is mounted at its ends to the respective short link and long link provided on the photovoltaic panel mounting assembly and particularly the support frame.

22. A dual axis solar tracker assembly as claimed in claim 21 configured such that rotation of the first elongate shaft or rod rotates the mounting assembly through the connection to the link members.

23. A dual axis solar tracker assembly as claimed in claim 13 wherein the elongate transverse link is pivotable about a pivot pin but force can be transmitted to the long link through the pivot pin which causes changes in angle of the mounting assembly.
